(19) United States
(12) Patent Application Publication
(10) Pub. No.: US 2018/0121057 A1
(43) Pub. Date: May 3, 2018

(54) METHOD AND DEVICE FOR HIDING APPLICATION ICON

(71) Applicant: Beijing Xiaomi Mobile Software Co., Ltd., Beijing (CN)

(72) Inventors: Zhe LIANG, Beijing (CN); Yin ZHU, Beijing (CN); Piao YANG, Beijing (CN)

(21) Appl. No.: 15/783,064

(22) Filed: Oct. 13, 2017

Related U.S. Application Data
(63) Continuation of application No. PCT/CN2016/104213, filed on Nov. 1, 2016.

(51) Int. Cl. G06F 3/0481; G06F 3/0486; G06F 3/0482; G06F 3/0488; G06F 21/31; G06F 21/62

(52) U.S. Cl. CPC G06F 3/04817; G06F 3/0486; G06F 21/629; G06F 3/04883; G06F 21/31; G06F 3/0482

(57) ABSTRACT

A method and device for hiding an application (APP) icon. The method includes monitoring, in a desktop interface, a hiding operation on a first APP icon by a second APP icon, the second APP icon being an APP icon of an installed APP; and hiding the first APP icon in the desktop interface.

### CROSS-REFERENCE TO RELATED APPLICATIONS

This application is a continuation of International Application No. PCT/CN2016/104213, filed on Nov. 1, 2016, the entire contents of which are incorporated herein by reference.

### TECHNICAL FIELD

The present disclosure generally relates to the field of computer technology and, more particularly, to a method and device for hiding an application (APP) icon.

### BACKGROUND

At present, various types of APPs may be installed in a terminal device, such as a mobile phone or a tablet computer, to expand functions of the terminal device. APP icons of various installed APPs are displayed in a desktop interface of the terminal device, and clicking on an APP icon by a user may trigger the terminal device to run the corresponding APP.

### SUMMARY

According to a first aspect of embodiments of the present disclosure, there is provided a method for hiding an application (APP) icon on a terminal device. The method includes: monitoring, in a desktop interface, a hiding operation for hiding a first APP icon by a second APP icon, the second APP icon being an APP icon of an installed APP; and hiding the first APP icon in the desktop interface.

According to a second aspect of embodiments of the present disclosure, there is provided a device for hiding an APP icon. The device includes: a processor; and a memory configured to store instructions executable by the processor. The processor is configured to: monitor, in a desktop interface, a hiding operation for hiding a first APP icon by a second APP icon, the second APP icon being an APP icon of an installed APP on the device; and hide the first APP icon in the desktop interface.

According to a third aspect of embodiments of the present disclosure, there is provided a non-transitory computer-readable storage medium having stored therein instructions that, when executed by a processor of a terminal device, cause the terminal device to perform a method for hiding an application (APP) icon. The method includes: monitoring, in a desktop interface, a hiding operation for hiding a first APP icon by a second APP icon, the second APP icon being an APP icon of an installed APP on the terminal device; and hiding the first APP icon in the desktop interface.

It is to be understood that both the foregoing general description and the following detailed description are only exemplary and explanatory and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart of a method for hiding an APP icon, according to an exemplary embodiment.

FIGS. 2(a)-2(c) are schematic diagrams illustrating exemplary interfaces according to exemplary embodiments.

FIG. 3 is a flow chart of a method for hiding an APP icon, according to another exemplary embodiment.

FIG. 4 is a flow chart of a method for hiding an APP icon, according to another exemplary embodiment.

FIG. 5 is a flow chart of a method for hiding an APP icon, according to another exemplary embodiment.

FIG. 6 is a block diagram of a device for hiding an APP icon, according to an exemplary embodiment.

FIG. 7 is a block diagram of a device for hiding an APP icon, according to another exemplary embodiment.

FIG. 8 is a block diagram of a device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

There is a need for a user to hide an APP icon in a desktop interface. For example, the user does not want others to view a certain APP installed in a terminal device, or the user does not want others to trigger a certain APP installed in the terminal device to run. In a related technology, the user may trigger a hidden APP interface to be displayed through a specific operation (such as a triple-click operation performed in the desktop interface) preset in the terminal device, and the hidden APP interface is arranged to place an APP icon needed to be hidden by the user. The hidden APP interface may only be triggered to be displayed by the above-mentioned specific operation. The user may add an APP icon into the hidden APP interface or click an APP icon in the hidden APP interface to trigger a corresponding APP to run.

The hidden APP icon is managed by the hidden APP interface in a unified manner, and the specific operation used for triggering the hidden APP interface to be displayed is preset in the terminal device. For example, the same specific operation is usually preset in terminal devices from the same manufacturer or of the same model number, so that others may view the APP icon hidden by the user in the hidden APP interface only by knowing the specific operation, and privacy of such a function is poor. On such a basis, embodiments of the present disclosure provide a method for hiding an APP icon and a device based on the method, so as to solve the problem existing in the related technology. According to the technical solutions provided by the present disclosure, the APP icon needed to be hidden by the user is hidden at any position in the desktop interface. For example, a second APP icon in the desktop interface other than the APP icon that needs to be hidden by the user, is arranged to hide the APP icon that needs to be hidden. Since the second APP icon used for hiding the APP icon may be arbitrarily selected by the user, others cannot easily trigger the hidden APP icon to be displayed due to not knowing a specific hiding position of the hidden APP icon, even though they know the operation for triggering the hidden APP icon to be displayed, and the privacy of the function is improved.

In exemplary embodiments of the present disclosure, the method for hiding an APP icon may be performed by a terminal device, such as a mobile phone, a tablet computer, an electronic book reader, a multimedia player, a Personal Digital Assistant (PDA), a wearable device and the like.

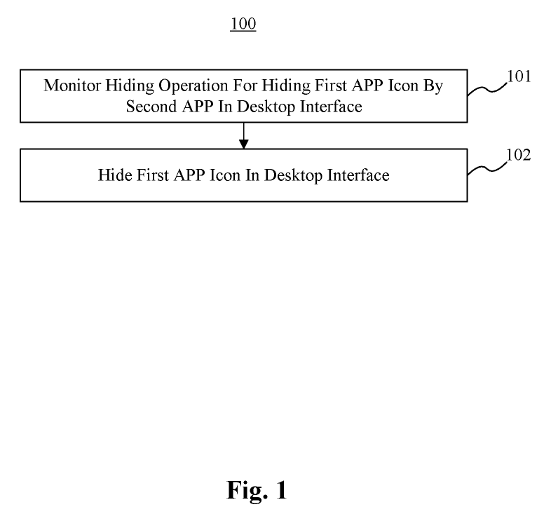

FIG. 1 is a flow chart of a method 100 for hiding an APP icon, according to an exemplary embodiment. The method 100 may include the following steps.

In step 101, a hiding operation for hiding a first APP icon by a second APP icon is monitored in a desktop interface.

In exemplary embodiments, the desktop interface is a primary interface displayed on the terminal device, and the desktop interface includes a plurality of APP icons. The APP icons are icons located in the desktop interface for running APPs. The APP icons are arranged to uniquely identify the APPs. Clicking on an APP icon may trigger the APP corresponding to the APP icon to run. The first APP icon is an APP icon, which is needed to be hidden, selected by a user. The second APP icon is an APP icon selected by the user to hide the first APP icon. Both of the first APP icon and the second APP icon may be APP icons in the desktop interface, so that hiding and calling of the APP icons may be implemented in the desktop interface, and convenience and efficiency for operation are achieved.

The second APP icon may be an APP icon of any installed APP. For example, the second APP icon is any APP icon except the first APP icons in the desktop interface. That is, any APP icon in the desktop interface except the first APP icon may be selected by the user to hide the first APP icon. In such a manner, others cannot easily trigger the hidden APP icon to be displayed due to not knowing a specific hiding position of the hidden APP icon, even though they know the operation for triggering the hidden APP icon to be displayed, and the privacy of the function is improved.

The hiding operation is an operation arranged to trigger the terminal device to hide the first APP icon.

In an exemplary embodiment, the hiding operation includes dragging the first APP icon to the second APP icon and then releasing the first APP icon. For example, the user executes a swipe operation starting from the first APP icon and ending at the second APP icon. Correspondingly, after detecting the swipe operation, the terminal device moves the first APP icon along a trajectory of the swipe operation.

In another exemplary embodiment, the hiding operation includes long-pressing the first APP icon, dragging the first APP icon to the second APP icon, and then releasing the first APP icon. For example, the user long-presses and drags the first APP icon to execute a swipe operation starting from the first APP icon and ending at the second APP icon. Correspondingly, the terminal device moves the first APP icon along the trajectory of the swipe operation.

In the above manner, the user may intuitively and definitely see the APP icon which needs to be hidden. In addition, in the above manner, the first APP icon may be hidden by the second APP icon only through one dragging operation, so that simplicity and high efficiency for operation are ensured.

In still another exemplary embodiment, the hiding operation includes: a first selection operation corresponding to the first APP icon and a second selection operation corresponding to the second APP icon. The first selection operation is any one of a click operation, a long-press operation, a press operation, and a swipe operation. The second selection operation is any one of a click operation, a long-press operation, a press operation, and a swipe operation. Correspondingly, the first APP icon is hidden by the second APP icon through the two selection operations.

The click operation is also called a tapping operation. Considering that a single-click operation on an APP icon is usually configured to trigger an APP corresponding to the APP icon to run, the first selection operation may be a multi-click operation, such as a double-click or triple-click operation. The long-press operation refers to an operation for which a press time length is larger than a preset time length. The press operation refers to an operation of which pressure is higher than preset pressure. In an example, if the first selection operation is a long-press operation and the second selection operation is a click operation, after acquiring the long-press operation on a certain APP icon, the terminal device determines that the APP icon is the first APP icon (i.e. the APP icon which needs to be hidden); and then, after acquiring the click operation on another APP icon, the terminal device determines that the other APP icon is the second APP icon (i.e. an APP icon arranged to hide the APP icon which needs to be hidden).

In the exemplary embodiment, the first APP icon is hidden by the second APP icon through the two selection operations.

In addition, in the exemplary embodiment, the condition that the first APP icon (i.e. the APP icon needs to be hidden) is first selected and the second APP icon (i.e. the APP icon arranged to hide the APP icon which needs to be hidden) is then selected. Alternatively, in another exemplary embodiment, the second APP icon (i.e. the APP icon arranged to hide the APP icon which needs to be hidden) may also be first selected and the first APP icon (i.e. the APP icon which needs to be hidden) is then selected. The embodiments of the present disclosure are not limited thereto.

In step 102, the first APP icon is hidden in the desktop interface.

In an exemplary embodiment, the terminal device deletes the first APP icon in the desktop interface.

In another exemplary embodiment, the terminal device displays the first APP icon in an invisible form in the desktop interface. For example, transparency of the first APP icon is regulated into complete transparency, or an appearance of the first APP icon is regulated to be the same as the desktop interface, so that an effect of hiding the first APP icon in the desktop interface is achieved.

In exemplary embodiments, any APP icon in the desktop interface may be arranged to hide another APP icon and may also be arranged to hide more other APP icons.

In addition, the terminal device may also store an association relationship between the first APP icon and the second APP icon for subsequent calling of the hidden first APP icon according to the association relationship. After a display position of the second APP icon in the desktop interface is changed, the first APP icon hidden by the second APP icon does not change, and the user may view and run an APP corresponding to the first APP icon hidden by the second APP icon by executing a hidden APP calling operation corresponding to the second APP icon.

The method 100 hides the first APP icon in the desktop interface when the hiding operation for hiding the first APP icon by the second APP icon is detected in the desktop interface, so that the problem of relatively poor privacy of an APP icon hiding function provided by the related technology is solved. Since the second APP icon used for hiding the APP icon may be arbitrarily selected by the user, others cannot easily trigger the hidden APP icon to be displayed due to not knowing a specific hiding position of the hidden APP icon, even though they know the operation for triggering the hidden APP icon to be displayed, and the privacy of the function is improved.

In an exemplary embodiment, the method 100 further includes the following steps.

1: After the first APP icon is dragged to the second APP icon and then the first APP icon is released, multiple options are displayed.

For example, the multiple options include a hiding option and a grouping option. The hiding option is configured to trigger selection of hiding the first APP icon by the second APP icon. The grouping option is configured to trigger selection of putting the first APP icon and the second APP icon in the same folder.

In addition, for different operation manners for hiding the first APP icon, the terminal device displays the multiple options at different times.

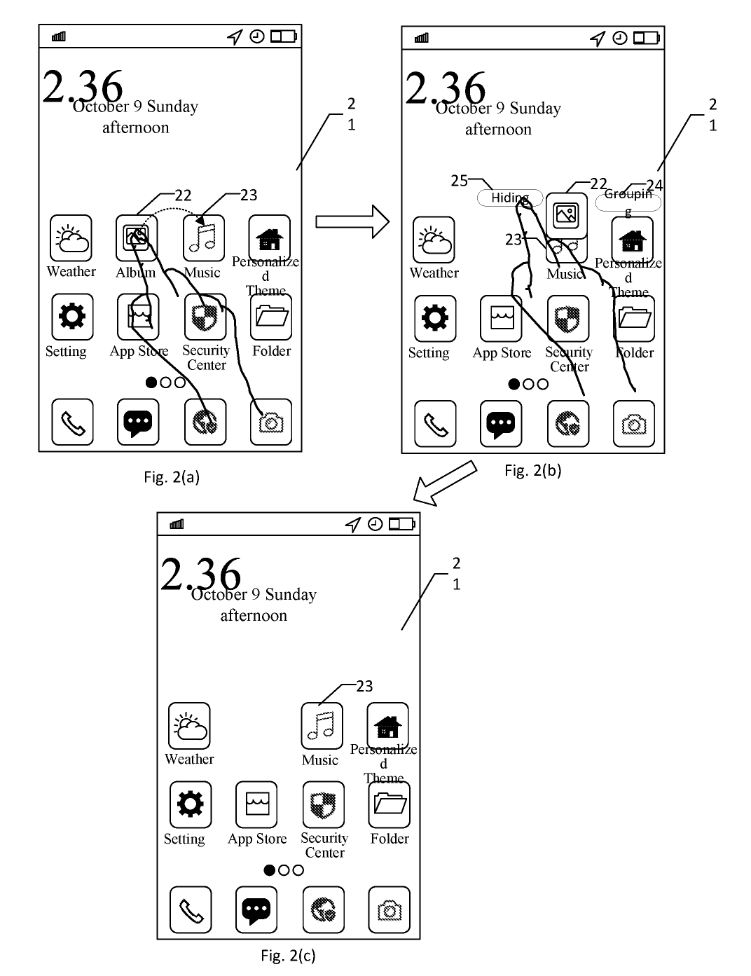

When the hiding operation is the dragging operation introduced in step 101, the terminal device may display the multiple options when detecting that the dragging operation is ended. Alternatively, the terminal device may display the multiple options when detecting that an area of an overlapping part of the first APP icon and the second APP icon is larger than a preset area. Referring to FIG. 2(a), the user executes a swipe operation starting from an “album” APP icon 22 in a desktop interface 21 and ending at a “music” APP icon 23 to trigger hiding of the “album” APP icon 22 by the “music” APP icon 23. Referring to FIG. 2(b), the terminal device displays a grouping option 24 and a hiding option 25 after acquiring the swipe operation.

When the hiding operation includes the two selection operations introduced in step 101, the terminal device may display the multiple options when acquiring the first selection operation, or display the multiple options when acquiring the second selection operation.

2: A selection operation of the hiding option is acquired to trigger execution of hiding the first APP icon in the desktop interface.

In some embodiments, the selection operation of the hiding option is a click operation. For example, referring to FIG. 2(b), after the user clicks the hiding option 25, the terminal device hides the “album” APP icon 22 in the desktop interface 21, and the desktop interface 21 after hiding is shown by FIG. 2(c).

In the above manner, a hiding function is expanded on the basis of original management functions in the APP icons.

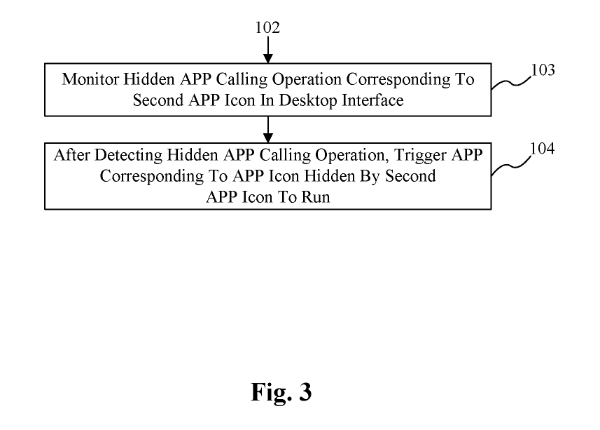

In another exemplary embodiment, shown in FIG. 3, after step 102, the method 100 further includes the following steps.

In step 103, a hidden APP calling operation corresponding to the second APP icon is monitored in the desktop interface.

The hidden APP calling operation is used to trigger an APP corresponding to the APP icon hidden by the second APP icon to run. The step includes at least one of the following implementation modes:

1: a multi-click operation on the second APP icon is monitored in the desktop interface;

2: a press operation on the second APP icon is monitored in the desktop interface; and

3: a swipe operation on the second APP icon is monitored in the desktop interface.

In step 104, after the hidden APP calling operation is detected, an APP corresponding to the APP icon hidden by the second APP icon is triggered to run.

If there is one APP icon hidden by the second APP icon, an APP corresponding to the APP icon hidden by the second APP icon is triggered to run. In an exemplary embodiment, after the hidden APP calling operation is acquired, the terminal device directly runs the APP corresponding to the APP icon hidden by the second APP icon. In another exemplary embodiment, after the hidden APP calling operation is acquired, the terminal device displays the APP icon hidden by the second APP icon, and when a display time length reaches a preset time length (such as 2 seconds) or an opening operation corresponding to the hidden APP icon is acquired, the terminal device runs the APP corresponding to the hidden APP icon. In addition, the terminal device may display the APP icon hidden by the second APP icon beside the second APP icon. Alternatively, the second APP icon may become a hidden APP icon.

If there are a plurality of APP icons hidden by the second APP icon, a hidden APP interface is displayed. The hidden APP interface includes the APP icons hidden by the second APP icon. An operation of selecting a target APP icon in the hidden APP interface is acquired, and an APP corresponding to the target APP icon is triggered to run. The hidden APP interface may be displayed in an upper layer of the desktop interface in an overlapping manner. In addition, an arrangement sequence of each APP icon in the hidden APP interface may be determined according to a preset sequencing rule. The preset sequencing rule may be a sequence according to which the terminal device hides each APP icon, or a sequence according to times/frequencies for which the terminal device runs APPs corresponding to each APP icon, etc. The preset sequencing rule may be set by the terminal device as a default rule, or may be set by the user in a customizable manner. In addition, the user may also adjust the arrangement sequence of the APP icons in the hidden APP interface in a customizable manner.

In the above manner, the APPs corresponding to the hidden APP icons may be rapidly run without a complex operation or input of a verification password, and both privacy and convenience are achieved.

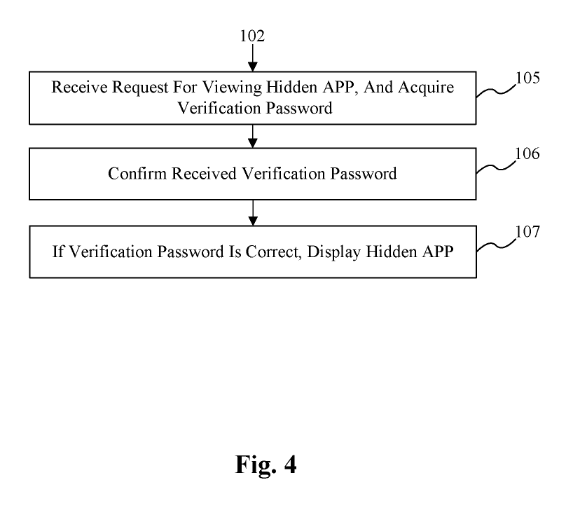

In another exemplary embodiment, shown in FIG. 4, after step 102, the method 100 further includes the following steps.

In step 105, a request for viewing the hidden APP is received, and a verification password is acquired.

The hidden APP is an APP corresponding to the hidden APP icon. The request for viewing is configured to request the terminal device to display the hidden APP for the user to view. The verification password is required to check an identity of the user, and the verification password may be an unlocking password of the terminal device, or a preset password dedicated to view the hidden APP.

In addition, in the embodiment of the present disclosure, an implementation form for the verification password is not limited. For example, the verification password may be a numeric password, a graphical password, a gesture password, a fingerprint and the like.

In step 106, the received verification password is confirmed.

The terminal device acquires the verification password input by the user, and compares the input verification password with a pre-stored verification password to confirm whether the received verification password is correct or not.

In step 107, if the verification password is correct, the hidden APP is displayed.

The hidden APP is displayed in a manner of being associated with the second APP icon. The first APP icon refers to an APP icon hidden by the second APP icon. There may be one first APP icon, or a plurality of first APP icons. The second APP icon is an APP icon arranged to hide the first APP icon. The terminal device stores an association relationship between the first APP icon and the second APP icon after hiding the first APP icon in the desktop interface by the second APP icon. In some embodiments, the terminal device stores a corresponding relationship between an APP identifier of the first APP icon and an APP identifier of the second APP icon, and marks the hidden first APP icon and/or the second APP icon arranged to hide the first APP icon. The APP identifiers of the APP icons may be names of the APPs of the APP icons.

The user may view the association relationship to know a subordinate hiding relationship between the APP icons. If the user forgets a hiding position of a certain APP icon, the user may view the association relationship to know the hiding position.

The user may also execute a dissociate operation on the association relationship to restore and display the hidden APP icon in the desktop interface. Correspondingly, the terminal device displays the first APP icon in the desktop interface when acquiring the dissociate operation corresponding to the association relationship between the first APP icon and the second APP icon.

In such a manner, when the request for viewing the hidden APP is acquired, the identity of the user is checked first, and the hidden APP is displayed to the user after the user passes verification, so that privacy and security of the hidden APP is sufficiently ensured.

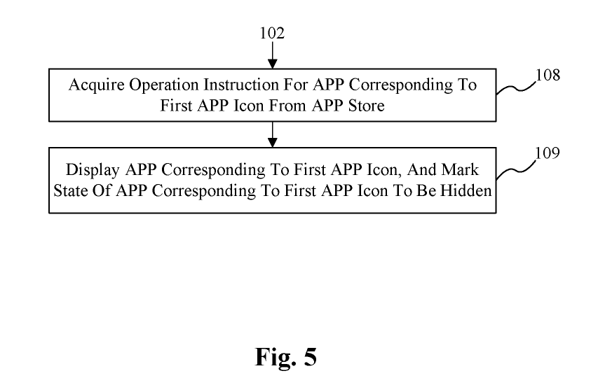

In another exemplary embodiment, shown in FIG. 5, after step 102, the method 100 further includes the following steps.

In step 108, an operation instruction for an APP is acquired from an APP store, the APP being corresponding to the first APP icon.

The first APP icon is a hidden APP icon. The APP store is an APP program to provide an APP, which may be downloaded and installed, for the terminal device. The APP store provides functions of searching, installation, updating, and the like for the APP. The operation instruction includes, but is not limited to, any one of a searching instruction, an installation instruction and an updating instruction.

In step 109, the APP corresponding to the first APP icon is displayed, and a state of the APP corresponding to the first APP icon is marked to be hidden.

For example, when the user searches the APP store for the APP corresponding to the hidden APP icon, the terminal device marks the state of the APP to be hidden.

In an exemplary embodiment, the terminal device forbids the user to trigger the APP corresponding to the hidden APP icon to run in the APP store. In another exemplary embodiment, when acquiring a running instruction of the APP corresponding to the first APP icon (for example, the first APP icon is a hidden APP icon) from the APP store, the terminal device displays prompting information configured to prompt input of the verification password, the terminal device acquires the input verification password, and in a case where the input verification password is correct, the terminal device runs the APP corresponding to the first APP icon.

In some embodiments, when acquiring a searching instruction for the APP corresponding to the first APP icon from another searching entry (such as a system global searching entry of the terminal device) except the APP store, the terminal device does not provide the APP corresponding to the first APP icon in a searching result to ensure privacy.

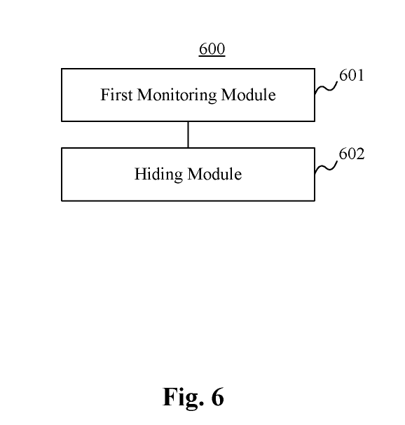

FIG. 6 is a block diagram of a device 600 for hiding an APP icon, according to an exemplary embodiment. The device 600 has a function of implementing the above described methods, and may be implemented by hardware, or software, or a combination of hardware and software. The device 600 may include: a first monitoring module 601 and a hiding module 602.

The first monitoring module 601 is configured to monitor, in a desktop interface, a hiding operation for hiding a first APP icon by a second APP icon, the second APP icon being an APP icon of an installed APP.

The hiding module 602 is configured to hide the first APP icon in the desktop interface.

The device 600 hides the first APP icon in the desktop interface when the hiding operation for hiding the first APP icon by the second APP icon is detected in the desktop interface, so that the problem of relatively poor privacy of an APP icon hiding function provided by the related technology is solved. Since another APP icon used for hiding the APP icon may be arbitrarily selected by the user, others cannot easily trigger the hidden APP icon to be displayed due to not knowing a specific hiding position of the hidden APP icon, even though they know the operation for triggering the hidden APP icon to be displayed, and the privacy of the function is improved.

In an exemplary embodiment, the hiding operation includes: dragging the first APP icon to the second APP icon and then releasing the first APP icon.

In an exemplary embodiment, the hiding operation includes: long-pressing the first APP icon, dragging the first APP icon to the second APP icon, and then releasing the first APP icon.

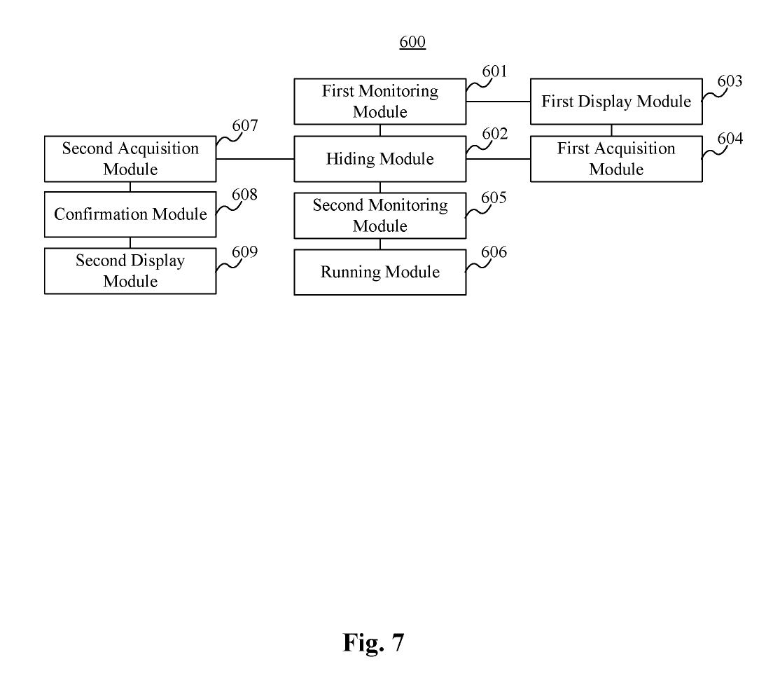

As shown in FIG. 7, the device 600 further includes: a first display module 603 and a first acquisition module 604.

The first display module 603 is configured to display multiple options after the first APP icon is dragged to the second APP icon and then released. The multiple options include a hiding option. The hiding option is configured to trigger selection of hiding the first APP icon by the second APP icon.

The first acquisition module 604 is configured to acquire a selection operation of the hiding option to trigger the hiding module 602 to execute the step of hiding the first APP icon in the desktop interface.

In another exemplary embodiment, shown in FIG. 7, the device 600 further includes: a second monitoring module 605 and a running module 606.

The second monitoring module 605 is configured to monitor, in the desktop interface, a hidden APP calling operation corresponding to the second APP icon.

The running module 606 is configured to, after the hidden APP calling operation is detected, run an APP corresponding to the APP icon hidden by the second APP icon.

The second monitoring module 605 is configured to: monitor, in the desktop interface, a multi-click operation on the second APP icon; monitor, in the desktop interface, a press operation on the second APP icon; or monitor, in the desktop interface, a swipe operation on the second APP icon.

The running module 606 is configured to: when there is one APP icon hidden by the second APP icon, run an APP corresponding to the APP icon hidden by the second APP icon; or, when there are a plurality of APP icons hidden by the second APP icon, display a hidden APP interface including the APP icons hidden by the second APP icon, acquire an operation for selecting a target APP icon in the hidden APP interface, and run an APP corresponding to the target APP icon.

In another exemplary embodiment, shown in FIG. 7, the device 600 further includes: a second acquisition module 607, a confirmation module 608, and a second display module 609.

The second acquisition module 607 is configured to receive a request for viewing the hidden APP, and acquire a verification password.

The confirmation module 608 is configured to confirm the received verification password.

The second display module 609 is configured to, if the verification password is correct, display the hidden APP in a manner of associating the hidden APP icon with the second APP icon.

In another exemplary embodiment, the device 600 further includes: a third acquisition module and a third display module (not shown).

The third acquisition module is configured to acquire, from an APP store, an operation instruction for an APP, the APP being corresponding to the first APP icon.

The third display module is configured to display the APP corresponding to the first APP icon, and mark a state of the APP corresponding to the first APP icon to be hidden.

The specific manners for performing operations for individual modules in the device 600 have been described in detail in the embodiments regarding the methods, which will not be elaborated herein.

An exemplary embodiment of the present disclosure further provides a device for hiding an APP icon. The device includes a processor, and a memory configured to store an executable instruction of the processor, wherein the processor is configured to: monitor, in the desktop interface, a hiding operation for hiding a first APP icon by a second APP icon in a desktop interface, the second APP icon being an APP icon of any installed APP; and hide the first APP icon in the desktop interface.

In one embodiment, the hiding operation includes: dragging the first APP icon to the second APP icon and then releasing the first APP icon.

In one embodiment, the hiding operation includes: long-pressing the first APP icon, and dragging the first APP icon to the second APP icon, and then releasing the first APP icon.

In one embodiment, the processor is further configured to: display multiple options after the first APP icon is dragged to the second APP icon and then released, the multiple options including a hiding option, and the hiding option being configured to trigger selection of hiding the first APP icon by the second APP icon; and acquire an operation of selecting the hiding option to trigger execution of the hiding the first APP icon in the desktop interface.

In one embodiment, the processor is further configured to: monitor, in the desktop interface, a hidden APP calling operation corresponding to the second APP icon; and after the hidden APP calling operation is detected, run an APP corresponding to the APP icon hidden by the second APP icon.

In one embodiment, the processor is configured to: monitor, in the desktop interface, a multi-click operation on the second APP icon; monitor, in the desktop interface, a press operation on the second APP icon; or monitor, in the desktop interface, a swipe operation on the second APP icon.

In one embodiment, the processor is configured to: when there is one APP icon hidden by the second APP icon, run an APP corresponding to the APP icon hidden by the second APP icon; or, when there are a plurality of APP icons hidden by the second APP icon, display a hidden APP interface including the APP icons hidden by the second APP icon, acquire an operation for selecting a target APP icon in the hidden APP interface, and run an APP corresponding to the target APP icon.

In one embodiment, the processor is further configured to: receive a request for viewing the hidden APP, and acquire a verification password; confirm the acquired verification password; and in a case where the verification password is correct, display the hidden APP in a manner of associating the hidden APP icon with the second APP icon.

In one embodiment, the processor is further configured to: acquire, from an APP store, an operation instruction for an APP, the APP being corresponding to the first APP icon; and display the APP corresponding to the first APP icon, and mark a state of the APP corresponding to the first APP icon to be hidden.

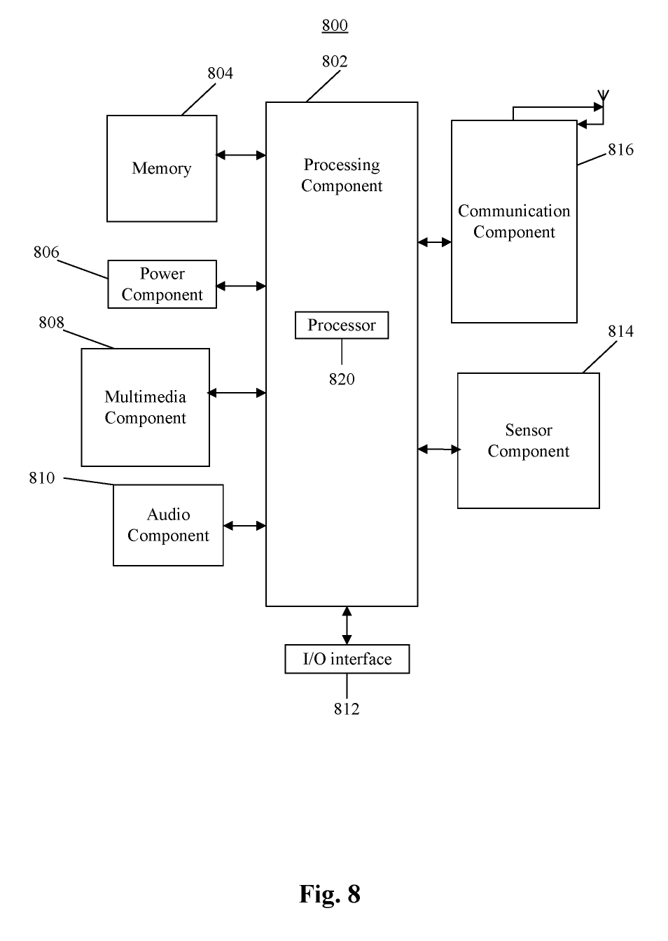

FIG. 8 is a block diagram of a device 800, according to an exemplary embodiment. For example, the device 800 may be a mobile phone, a computer, a digital broadcast terminal, a messaging device, a gaming console, a tablet, a medical device, exercise equipment, a PDA and the like.

Referring to FIG. 8, the device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the device 800. Examples of such data include instructions for any application programs or methods operated on the device 800, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power for various components of the device 800. The power component 806 may include a power management system, one or more power supplies, and other components associated with the generation, management and distribution of power for the device 800.

The multimedia component 808 includes a screen providing an output interface between the device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 808 includes a front camera and/or a rear camera. The front camera and/or the rear camera may receive external multimedia data, when the device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a microphone configured to receive an external audio signal when the device 800 is in the operation mode, such as a call mode, a recording mode and a voice recognition mode. The received audio signal may be further stored in the memory 804 or sent through the communication component 816. In some embodiments, the audio component 810 further includes a speaker for outputing the audio signal.

The I/O interface 812 provides an interface between the processing component 802 and a peripheral interface module, and the peripheral interface module may be a keyboard, a click wheel, a button and the like. The button may include, but is not limited to: a home button, a volume button, a running button and a locking button.

The sensor component 814 includes one or more sensors for providing status assessment in various aspects for the device 800. For instance, the sensor component 814 may detect an on/off status of the device 800 and relative positioning of components such as a display and a keypad of the device 800, and the sensor component 814 may further detect a change in a position of the device 800 or a component of the device 800, presence or absence of contact between the user and the device 800, orientation or acceleration/deceleration of the device 800 and a change in temperature of the device 800. The sensor component 814 may include a proximity sensor configured to detect presence of an object nearby without any physical contact. The sensor component 814 may further include an optical sensor, such as a Complementary Metal Oxide Semiconductor (CMOS) or Charge Coupled Device (CCD) image sensor, configured for use in an imaging application. In some embodiments, the sensor component 814 may further include an acceleration sensor, a gyroscope sensor, a magnetic sensor, a pressure sensor or a temperature sensor.

The communication component 816 is configured to facilitate wired or wireless communication between the device 800 and another device. The device 800 may access a communication-standard-based wireless network, such as a Wireless Fidelity (Wi-Fi) network, a 2nd-Generation (2G) or 3rd-Generation (3G) network, or a combination thereof. In an exemplary embodiment, the communication component 816 receives a broadcast signal or broadcast associated information from an external broadcast management system through a broadcast channel. In an exemplary embodiment, the communication component 816 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BlueTooth (BT) technology and another technology.

In an exemplary embodiment, the device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, for performance of the abovementioned methods.

In an exemplary embodiment, there is also provided a non-transitory computer-readable storage medium including instructions, such as included in the memory 804, executable by the processor 820 of the device 800, to perform the above described methods. For example, the non-transitory computer-readable storage medium may be a Read-Only Memory (ROM), a Radom Access Memory (RAM), a Compact Disc Read-Only Memory (CD-ROM), a magnetic tape, a floppy disc, an optical data storage device and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for hiding an application (APP) icon on a terminal device, comprising:
monitoring, in a desktop interface, a hiding operation for hiding a first APP icon by a second APP icon, the second APP icon being an APP icon of an installed APP on the terminal device; and
hiding the first APP icon in the desktop interface.

2. The method according to claim 1, wherein monitoring the hiding operation comprises:
monitoring a first operation of dragging the first APP icon to the second APP icon; and
monitoring a second operation of releasing the first APP icon.

3. The method according to claim 1, wherein monitoring the hiding operation comprises:
monitoring a first operation of long-pressing the first APP icon;
monitoring a second operation of dragging the first APP icon to the second APP icon; and
monitoring a third operation of releasing the first APP icon.

4. The method according to claim 2, further comprising:
displaying multiple options including a hiding option, the hiding option being configured to trigger selection of hiding the first APP icon by the second APP icon; and
acquiring a selection operation of the hiding option to trigger execution of the hiding the first APP icon in the desktop interface.

5. The method according to claim 1, further comprising:
monitoring, in the desktop interface, a hidden APP calling operation corresponding to the second APP icon; and
running an APP corresponding to an APP icon hidden by the second APP icon after the hidden APP calling operation is detected.

6. The method according to claim 5, wherein monitoring, in the desktop interface, the hidden APP calling operation corresponding to the second APP icon comprises at least one of:
monitoring, in the desktop interface, a multi-click operation on the second APP icon;
monitoring, in the desktop interface, a press operation on the second APP icon; or
monitoring, in the desktop interface, a swipe operation on the second APP icon.

7. The method according to claim 5, wherein running the APP corresponding to the APP icon hidden by the second APP icon comprises:
if there is one APP icon hidden by the second APP icon, running an APP corresponding to the APP icon hidden by the second APP icon; and
if there are a plurality of APP icons hidden by the second APP icon, displaying a hidden APP interface including the APP icons hidden by the second APP icon, acquiring an operation of selecting a target APP icon in the hidden APP interface, and running an APP corresponding to the target APP icon.

8. The method according to claim 1, further comprising:
receiving a request for viewing the hidden APP, and acquiring a verification password;
confirming the acquired verification password; and
if the verification password is correct, displaying the hidden APP in a manner of associating the hidden APP icon with the second APP icon.

9. The method according to claim 1, further comprising:
acquiring, from an APP store, an operation instruction for an APP corresponding to the first APP icon; and
displaying the APP corresponding to the first APP icon, and marking a state of the APP corresponding to the first APP icon to be hidden.

10. A device for hiding an application (APP) icon, comprising:
a processor; and
a memory configured to store instructions executable by the processor,
wherein the processor is configured to:
monitor, in a desktop interface, a hiding operation for hiding a first APP icon by a second APP icon, the second APP icon being an APP icon of an installed APP on the device; and
hide the first APP icon in the desktop interface.

11. The device according to claim 10, wherein the processor is further configured to:
monitor a first operation of dragging the first APP icon to the second APP icon; and
monitor a second operation of releasing the first APP icon.

12. The device according to claim 11, wherein the processor is further configured to:
monitor a first operation of long-pressing the first APP icon;
monitor a second operation of dragging the first APP icon to the second APP icon; and
monitor a third operation of releasing the first APP icon.

13. The device according to claim 12, wherein the processor is further configured to:
display multiple options including a hiding option, the hiding option being configured to trigger selection of hiding the first APP icon by the second APP icon; and
acquire a selection operation of the hiding option to trigger execution of the hiding the first APP icon in the desktop interface.

14. The device according to claim 10, wherein the processor is further configured to:
monitor, in the desktop interface, a hidden APP calling operation corresponding to the second APP icon; and
run an APP corresponding to an APP icon hidden by the second APP icon, after the hidden APP calling operation is detected.

15. The device according to claim 14, wherein the processor is configured to perform at least one of:
monitoring, in the desktop interface, a multi-click operation on the second APP icon;
monitoring, in the desktop interface, a press operation on the second APP icon; or
monitoring, in the desktop interface, a swipe operation on the second APP icon.

16. The device according to claim 14, wherein the processor is configured to:
if there is one APP icon hidden by the second APP icon, run an APP corresponding to the APP icon hidden by the second APP icon; and
if there are a plurality of APP icons hidden by the second APP icon, display a hidden APP interface including the APP icons hidden by the second APP icon, acquire an operation of selecting a target APP icon in the hidden APP interface, and run an APP corresponding to the target APP icon.

17. The device according to claim 10, wherein the processor is further configured to:
receive a request for viewing the hidden APP, and acquire a verification password;
confirm the acquired verification password; and
display the hidden APP in a manner of associating the hidden APP icon with the second APP icon, if the verification password is correct.

18. The device according to claim 10, wherein the processor is further configured to:
acquire, from an APP store, an operation instruction for an APP corresponding to the first APP icon; and
display the APP corresponding to the first APP icon, and mark a state of the APP corresponding to the first APP icon to be hidden.

19. A non-transitory computer-readable storage medium having stored therein instructions that, when executed by a processor of a terminal device, cause the terminal device to perform a method for hiding an application (APP) icon, the method comprising:
monitoring, in a desktop interface, a hiding operation for hiding a first APP icon by a second APP icon, the second APP icon being an APP icon of an installed APP on the terminal device; and
hiding the first APP icon in the desktop interface.

20. The non-transitory computer-readable storage medium according to claim 19, wherein monitoring the hiding operation comprises:
monitoring a first operation of dragging the first APP icon to the second APP icon; and
monitoring a second operation of releasing the first APP icon.
